(19) United States
(12) Patent Application Publication
(10) Pub. No.: US 2001/0032950 A1
(43) Pub. Date: Oct. 25, 2001

(54) Optimal sealability base for a gas management valve

(76) Inventors: Raul A. Bircann, Penfield, NY (US); Dwight O. Palmer, Rochester, NY (US)

Correspondence Address: Delphi Technologies, Inc., Mail Code 480414420, P.O. Box 5052, Troy, MI, 48007, US

(21) Appl. No.: 09/788,738

(22) Filed: Feb. 20, 2001

Related U.S. Application Data
(60) Provisional application No. 60/184,584, filed on Feb. 24, 2000.

(51) Int. Cl. F16K 31/02

(52) U.S. Cl. 251/129.15

(57) ABSTRACT

A novel spatial arrangement of valve ports and hold-down bolt holes in the body of an exhaust gas recirculation valve, wherein the centers of the ports are between and aligned with the centers of the bolt holes, thereby producing maximum sealing force around the ports against the surface to which the valve is bolted, such as the exhaust and intake manifolds of an internal combustion engine.

### CROSS-REFERENCE TO RELATED APPLICATIONS

This application claims the benefit of U.S. Provisional Application, Ser. No. 60/184,584, filed Feb. 24, 2000.

### TECHNICAL FIELD

The present invention relates to pintle-type valves; more particularly to pintle valves for permitting the controlled admission of exhaust gases into the fuel intake manifold of an internal combustion engine; and most particularly to a pintle valve having optimal sealability of the valve body to an attached substrate.

### BACKGROUND OF THE INVENTION

It is well known in the automotive art to provide a variable valve connecting the exhaust manifold with the intake manifold of an internal combustion engine to permit selective and controlled recirculation of a portion of an engine's exhaust gas into the fuel intake stream. Such recirculation is beneficial for reducing the burn temperature of the fuel mix in the engine to reduce formation of nitrogen and sulfur oxides which are significant components of smog. Such a valve is known in the art as an exhaust gas recirculation (EGR) valve.

Typically, an EGR valve has a valve body enclosing a chamber disposed between a first port in the exhaust manifold and a second port in the intake manifold; a valve seat dividing the chamber between the two ports; a valve pintle having a valve head fitted to the valve seat and a valve stem extending from the valve head through a bearing mounted in a third port in a sidewall of the valve body; a spring-retained bearing splash shield; and a solenoid actuator mounted on the exterior of the valve body and operationally connected to the outer end of the valve pintle.

A problem inherent to known EGR valves is that leakage can develop along the interface between the valve body and the exhaust and intake manifolds. Leakage between the connecting ports on the manifolds is, by definition, not metered flow and therefore not controlled. Such unintended flow can cause the engine to run rough or to ultimately stall. Additionally, unmetered external air can be ingested by the engine, thereby causing surges that can result in dangerous driving conditions, particularly in inclement weather. Such undesirable conditions can have the further effects of increasing wear on brakes and other components and of causing customer dissatisfaction.

It has been found that known EGR valves typically have ports for connecting to manifold ports which are significantly out of line with the force hold-down line generated by the pattern of bolt holes in the valve body. Thus, the sealing force exerted around the ports is not maximized for the degree of torque on the sealing bolts. A further shortcoming of some known EGR valves is that more than two bolts are required to attach the valve, which increases the cost of manufacture. Further, in assembly, it can be quite difficult to tighten three or more bolts equally. In sequential tightening, the tightening of each bolt influences the degree of tightening of all previous bolts, thus requiring tightening iteration. Tightening of all bolts simultaneously is expensive and difficult to perform and does not guarantee uniform torque. With uneven tightening, the valve is susceptible to distortion and outright fracture. Thus a valve attachable at no more than two points is optimal.

What is needed is an improved spatial relationship between the valve ports and the valve hold-down bolts wherein the sealing force on the ports is maximized and the number of hold-down bolts is limited to two.

### SUMMARY OF THE INVENTION

The present invention is directed to a novel spatial arrangement of valve ports and hold-down bolt holes in the body of an exhaust gas recirculation valve, wherein the centers of the ports are between and aligned with the centers of the bolt holes, thereby producing maximum sealing force around the ports against the surface to which the valve is bolted, such as the exhaust and intake manifolds of an internal combustion engine.

### BRIEF DESCRIPTION OF THE DRAWINGS

The foregoing and other objects, features, and advantages of the invention, as well as presently preferred embodiments thereof, will become more apparent from a reading of the following description in connection with the accompanying drawings, in which:

FIG. 1 is a cross-sectional elevational view of a prior art ECR valve;

FIG. 2 is an isometric view of the prior art EGR valve shown in FIG. 1;

FIG. 3 is a plan view of the mating surface of the valve body of the prior art EGR valve shown in FIGS. 1 and 2, showing non-aligned relationship of the valve ports with the bolt holes in the valve body;

FIG. 4 is a plan view like that shown in FIG. 3, showing an improved EGR valve body arranged in accordance with the invention; and

FIG. 5 is an elevational cross-sectional view of an EGR valve assembly comprising the view taken along line 5-5 in the improved valve body shown in FIG. 4.

### DESCRIPTION OF THE PREFERRED EMBODIMENT

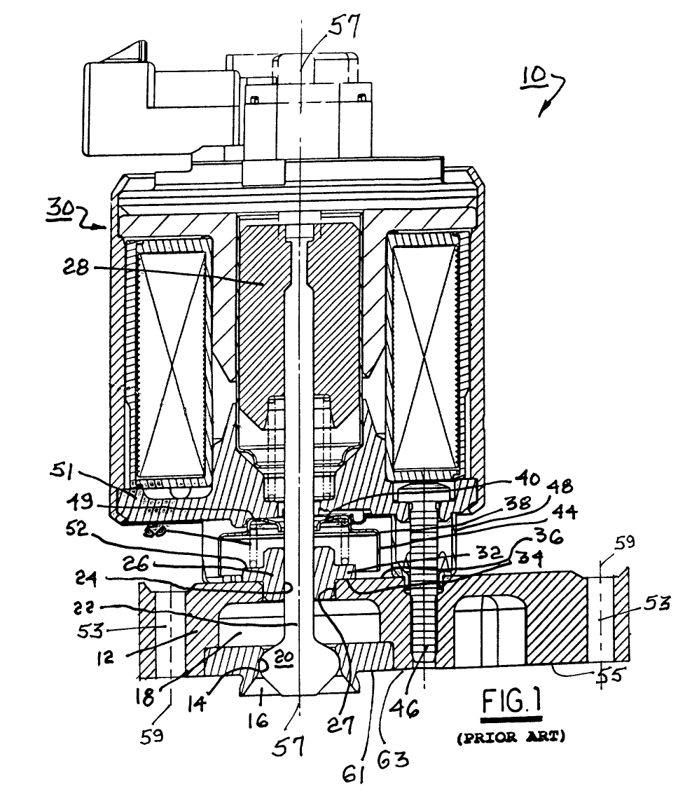

The benefits afforded by the present invention will become more readily apparent by first considering a prior art pintle valve. Referring to FIG. 1, a prior art EGR valve assembly 10 includes a valve body 12 having a valve seat 14 separating a first chamber 16 from a second chamber 18, which chambers may communicate with the exhaust and intake systems, respectively, of an internal combustion engine (not shown) or the reverse. Valve head 20 is disposed adjacent to seat 14 for selectively mating therewith to open or to close communication between chambers 16 and 18. Valve stem, or pintle, 22 extends from head 20 through an axial bore 24 in bearing 26 and is captured within armature 28 of solenoid actuator 30. Bearing 26 is disposed in a port 27 in a wall of valve body 12 and guides stem 22 in reciprocating motion to open and close the valve when actuator 30 is energized and de-energized, respectively.

Bearing 26 is provided with a circumferential flange 32 having a first axial face 34 for sealing against axial outer surface 36 of valve body 12 to prevent leakage of gases therebetween. A cup-shaped bearing splash shield 38 has an inward-extending flange 40 with a central aperture for passage of stem 22, preferably without contact therebetween, and a cylindrical skirt 44 extending axially to shield a substantial portion of bearing 26 from external contaminants. Shield 38 is open in a downwards direction to permit venting of any gases which may leak along bore 24 during operation of the valve. Actuator 30 is connected to valve body 12 via a plurality of bolts 46 extending through a plurality of standoffs 48. A coil spring 50 surrounding stem 22 is disposed within shield 38, being compressed between actuator 30 and a second surface 52 on flange 32 for urging flange 32 to seal against surface 36 under all operating conditions. Spring 50 also serves to urge shield 38 against surface 49 of primary polepiece 51 of actuator 30 to prevent dust intrusion into the actuator. Valve assembly 10 may be attached along sealing surface 55 to a substrate, such as the exhaust and intake manifolds of an internal combustion engine (not shown), by extending bolts (not shown) through bolt holes 53 in valve body 12. A conventional fiber, composite, or preferably metal gasket (not shown) may be installed between the valve body and the substrate.

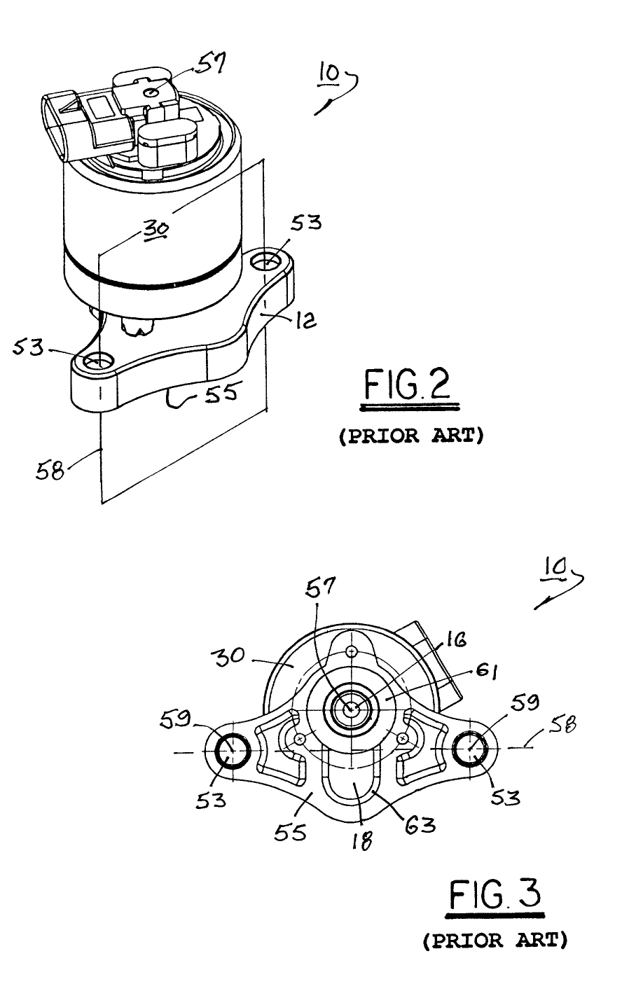

Referring to FIGS. 2 and 3, the operational axis 57 of valve assembly 12 is offset from the line of bolt holes 53; that is, any plane containing axis 57 is not coincident with a plane 58 containing the axes 59 (FIG. 1) of bolt holes 53. Plane 58 contains the maximum force vectors normal to surface 55. The sealing force exerted on the valve body by bolts in holes 53 is greatest immediately around holes 53 and in the line directly between holes 53. The sealing force decays in proportion to vector and distance from that line. Thus, the normal force to seal surfaces 61 and 63 surrounding ports 16 and 18, respectively, against a substrate must be less than the maximum possible for any given bolt torque in holes 53.

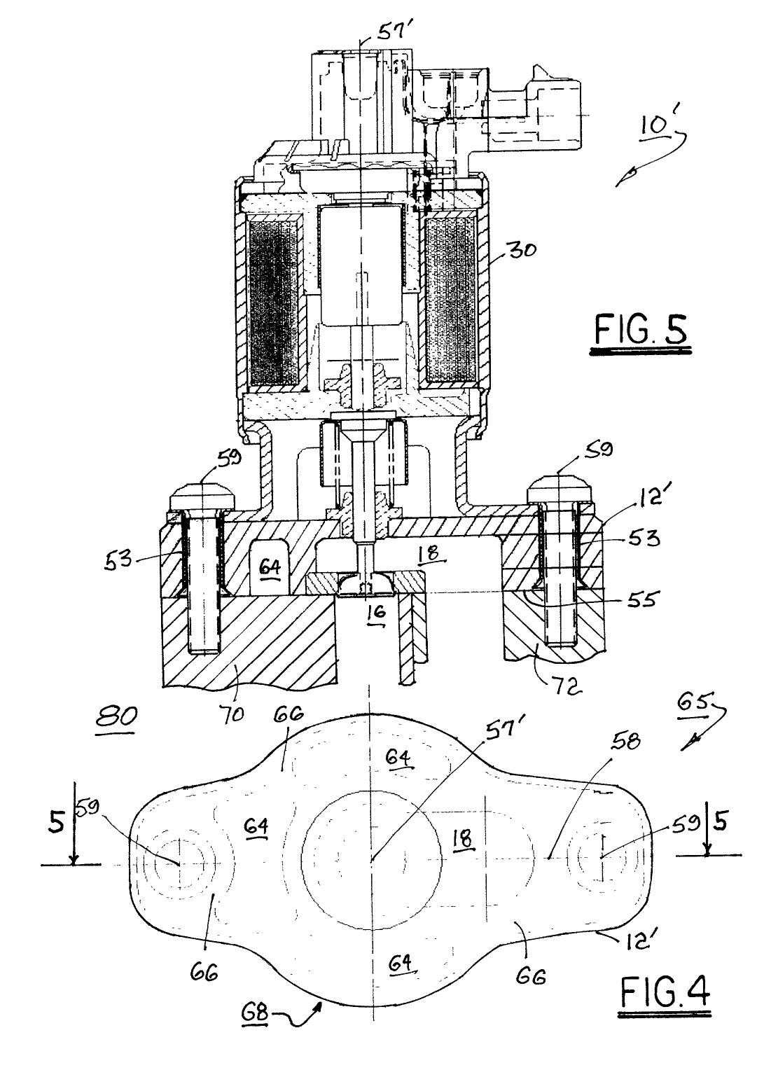

Referring to FIGS. 4 and 5, a preferred embodiment 65 of an improved valve body 12′ provides the maximum normal force possible on the sealing surfaces with minimum distortion and deformation of valve body 12′ under angular or wrenching loads on the valve. Relative to prior art valve body 12, the operational axis 57′ is moved into the plane 58 containing bolt hole axes 59 (coincident with the section along line 5-5). Further, port 18 is rotated 90° such that it and port 16 are bisected symmetrically by plane 58. Further, valve body 12′ is relieved by cutouts 64 which favorably reduce both the mass of the valve and the area for sealing, thereby increasing the unit sealing force on the remaining lands 66. Body 12′ is shown attached to actuator 30 in FIG. 5 to form an improved valve assembly 10′. Preferably, the circular portion 68 of valve body 12′ is substantially of the same diameter as actuator 30 to provide stability without excessive mass and volume in body 12′.

Valve assembly 10′ in accordance with the invention is especially useful as an exhaust gas recirculation valve disposed in known fashion between the exhaust manifold 70 and the intake manifold 72 of an internal combustion engine 70.

The foregoing description of the preferred embodiment of the invention has been presented for the purpose of illustration and description. It is not intended to be exhaustive nor is it intended to limit the invention to the precise form disclosed. It will be apparent to those skilled in the art that the disclosed embodiments may be modified in light of the above teachings. The embodiments described are chosen to provide an illustration of principles of the invention and its practical application to enable thereby one of ordinary skill in the art to utilize the invention in various embodiments and with various modifications as are suited to the particular use contemplated. Therefore, the foregoing description is to be considered exemplary, rather than limiting, and the true scope of the invention is that described in the following claims.

What is claimed is:

1. A valve body for a pintle-type valve wherein the operational axis of the valve is contained in a plane containing the maximum attachment force normal to the attachment surface of said valve when said valve is attached on said attachment surface to a substrate.

2. A valve body in accordance with claim 1 wherein said valve body is provided with at least two bores for receiving fasteners for attaching said valve body to said substrate, axes of said bores being disposed in said plane.

3. A valve body in accordance with claim 2 wherein inlet and outlet ports thereof are disposed symmetrically about said plane.

4. A valve body in accordance with claim 3 wherein said inlet and outlet ports are disposed between said bores.

5. A pintle-type valve assembly, comprising:
a) a valve body wherein the operational axis of the valve is contained in a plane containing the maximum attachment force normal to the attachment surface of said valve when said valve is attached on said attachment surface to a substrate; and
b) an actuator attached to said valve body for actuating said valve.

6. An exhaust gas recirculation valve assembly, comprising:
a) a valve body wherein the operational axis of the valve is contained in a plane containing the maximum attachment force normal to the attachment surface of said valve when said valve is attached on said attachment surface to a substrate; and
b) an actuator attached to said valve body for actuating said valve.

7. An internal combustion engine, comprising an exhaust gas recirculation valve having a valve body wherein the operational axis of the valve is contained in a plane containing the maximum attachment force normal to the attachment surface of said valve when said valve is attached on said attachment surface to a substrate.
